(19) United States
(12) Patent Application Publication
(10) Pub. No.: US 2024/0115973 A1
(43) Pub. Date: Apr. 11, 2024

(54) DOMESTIC AUTOMATIC EXTRACTION DEVICE FOR EXTRACTING AN OIL SUBSTANCE FROM PLANT MATERIAL

(71) Applicant: TINCOIL LTD., Tel Aviv (IL)

(72) Inventors: Yaacov BUXDORF, Ness-Ziona (IL); Yuval COHEN FLAX, Moshav Kisalon (IL); Dov OPPENHEIM, Tel Aviv (IL); Shir LEVY, Tel Aviv (IL); Noam YAISH, Tel Aviv (IL); Yotam ARIE, Ramat Gan (IL)

(73) Assignee: TINCOIL LTD., Tel Aviv (IL)

(21) Appl. No.: 18/286,266

(22) PCT Filed: Apr. 11, 2022
(86) PCT No.: PCT/IL2022/050372

§ 371 Date: Oct. 10, 2023

Related U.S. Application Data
(60) Provisional application No. 63/173,464, filed on Apr. 11, 2021.

(51) Int. Cl. B01D 11/04

(52) U.S. Cl. CPC B01D 11/0484

(57) ABSTRACT

An automatic extraction device for extracting a liquid substance (e.g., oil) from plant material, is disclosed. The device comprising: an ethanol source, a mixing tank, in liquid connection with the ethanol source, comprising: an entrance for providing the plant material; a mixer, and an exit for extracting a mixture of the ethanol and the liquid substance, an evaporation system, in liquid connection to the mixing tank's exit, for evaporating the ethanol; and a condenser, for condensing the evaporated ethanol, the condenser. In some embodiments, the condenser may include: an entrance in gas connection with the evaporation system; a housing having a maximum external volume of at most 1 liter; and an internal array of heatsinks, located inside the housing, providing a surface-to-volume ratio of 4-0.5 [1/mm]; and a collecting tube, in liquid connection to the mixing tank, for collecting the condensed ethanol.

### CROSS-REFERENCE

This application claims the benefit of priority of U.S. Provisional Patent Application No. 63/173,464, titled “DOMESTIC AUTOMATIC EXTRACTION DEVICE FOR EXTRACTING AN OIL SUBSTANCE FROM PLANT MATERIAL”, filed Apr. 11, 2021, the content of which are all incorporated herein by reference in their entirety.

### FIELD OF THE INVENTION

The present invention relates generally to automatic extraction device for extracting an oil substance from plant material. More specifically, the present invention relates to a domestic automatic extraction device for extracting an oil substance from plant material.

### BACKGROUND OF THE INVENTION

Automatic extraction devices for extracting a liquid substance from plant material are well known. These devices use a variety of solvents, such as, alcohol, butane, supper critical CO₂, water, and ethanol to extract oil or other liquid substance from plant material.

In all extraction methods, the plant material (e.g., cannabis flowers) are mixed with the solvent to extract the liquid substance (e.g., cannabis oil) from the plant. In the next step, the solvent is evaporated from the mixture, leaving the oil substance to be collected.

Most of the known devices are industrial or laboratory scale devices, to be used and operated by professionals. These industrial or laboratory scale devices are highly expensive (e.g., between $20K to $500K for cannabis oil extraction devices), complicated to operate, require large reservoirs of solvents and are suitable for commercial production.

Accordingly, there is a need for a domestic extraction device, that can easily produce domestic quantities of liquid substance having a commercial quality. This domestic extraction device may be easy to operate by a nonprofessional.

### SUMMARY OF THE INVENTION

Some aspects of the invention may be directed to a domestic automatic extraction device for extracting a liquid substance (e.g., oil) from plant material, comprising: an ethanol source, a mixing tank, in liquid connection with the ethanol source, comprising: an entrance for providing the plant material; a mixer, and an exit for extracting a mixture of the ethanol and the liquid substance, an evaporation system, in liquid connection to the mixing tank's exit, for evaporating the ethanol; and a condenser, for condensing the evaporated ethanol, the condenser. In some embodiments, the condenser may include: an entrance in gas connection with the evaporation system; a housing having a maximum external volume of at most 1 liter (e.g., at most 0.8 liter, 0.7 liter, 0.5 liter and any value in between); and an internal array of heatsinks, located inside the housing, providing a surface-to-volume ratio of 4-0.5 [1/mm] (e.g., a ratio of, 3-1, [1/mm], 3-0.5 [1/mm], 2-1 [1/mm] and any value in between); and a collecting tube, in liquid connection to the mixing tank, for collecting the condensed ethanol.

In some embodiments, the domestic automatic extraction device may further include an ethanol supply in fluid connection to the mixing tank and the condenser. In some embodiments, the housing may include two portions configured to form a sealed housing, and wherein a first group of heatsinks from the array is connected to a first portion of the housing and a second group of heatsinks from the array is connected to a second portion of the housing. In some embodiments, when assembled, the first group of heatsinks is configured to intertwine with the second group of heatsinks.

In some embodiments, the condenser may further include an external ventilation system. In some embodiments, the domestic automatic extraction device may further include a controller configured to control at least the mixer and the evaporation system.

Some aspects of the invention may be directed to a domestic automatic extraction device for extracting a liquid substance (e.g., oil) from plant material comprising: an ethanol source; a mixing tank, comprising: an entrance for providing the plant material; a mixer, in liquid connection with the ethanol source; and an exit for extracting a mixture of the ethanol and the liquid substance. In some embodiments, the domestic automatic extraction device further includes an evaporation system, in liquid connection to the mixing thank exit, for evaporating the ethanol; and a condenser, for condensing the evaporated ethanol. In some embodiments, the evaporation system comprises: a vessel for receiving the mixture, the vessel is made from a thermoplastic polymer; and at least one heating element placed in a distance from an external wall of the vessel, wherein the distance is determined based on the Tg of the thermoplastic polymer and the power provided by the at least one heating element, as to cause the vessel to be heated to 80-140° C.

In some embodiments, the thermoplastic polymer is selected from, silicone, Polytetrafluoroethylene, thermoplastic elastomer, and thermoplastic rubber. In some embodiments, the device may further include a controller configured to control a power provided to the at least one heating element to heat the vessel to a temperature of at least 80-140° C. In some embodiments, the device may further include a thermometer configured to measure the temperature of the mixture in the vessel and wherein the controller is configured to control the power provided to the heating elements based on signals received from the thermometer. In some embodiments, the thermometer is a thermistor attached to a wall of the vessel.

In some embodiments, the device may further include a holder for holding the vessel and the at least one heating element.

Some additional aspects of the invention may be directed to a system for automatic extraction of a liquid substance from plant material, comprising: two or more automatic extraction devices; and a controller configured to: control the provision of power to each one of the two or more automatic extraction devices. In some embodiments, each automatic extraction device comprises: a mixing tank, in liquid connection with the ethanol reservoir, comprising: an entrance for providing the plant material; a mixer; and an exit for extracting a mixture of the ethanol and the liquid substance. In some embodiments, each automatic extraction device may further include, an evaporation system, in liquid connection to the mixing tank's exit, for evaporating the ethanol; a condenser, for condensing the evaporated ethanol; and a collecting tube, in liquid connection to the mixing tank, for collecting the condensed ethanol.

In some embodiments, the condenser comprises an entrance in gas connection with the evaporation system; a housing having a maximum external volume of at most 1 liter; and an internal array of heatsinks, located inside the housing, providing a surface-to-volume ratio of 4-0.5 [1/mm].

In some embodiments, the evaporation system comprises: a vessel for receiving the mixture, the vessel is made from a thermoplastic polymer; and at least one heating element placed at a distance from an external wall of the vessel, wherein the distance is determined based on the Tg of the thermoplastic polymer and the power provided by the at least one heating element, as to cause the vessel to be heated to 80-140° C.

In some embodiments, the controller is configured to control at least the mixer and the evaporation system. In some embodiments, the controller is configured to control a power provided to the at least one heating element to heat the vessel to a temperature of at least 80-140° C.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are illustrations of a front view and a perspective view of an automatic extraction device for extracting a liquid substance from plant material according to some embodiments of the invention;

FIGS. 2A and 2B are detailed illustrations of an evaporation system for an automatic extraction device for extracting an oil substance from plant material according to some embodiments of the invention;

FIG. 3 is a detailed illustration of the components (exploded view) of a condenser for an automatic extraction device for extracting a liquid substance from plant material according to some embodiments of the invention; and

FIG. 4 is a block diagram of an automatic extraction system for extracting a liquid substance from plant material according to some embodiments of the invention.

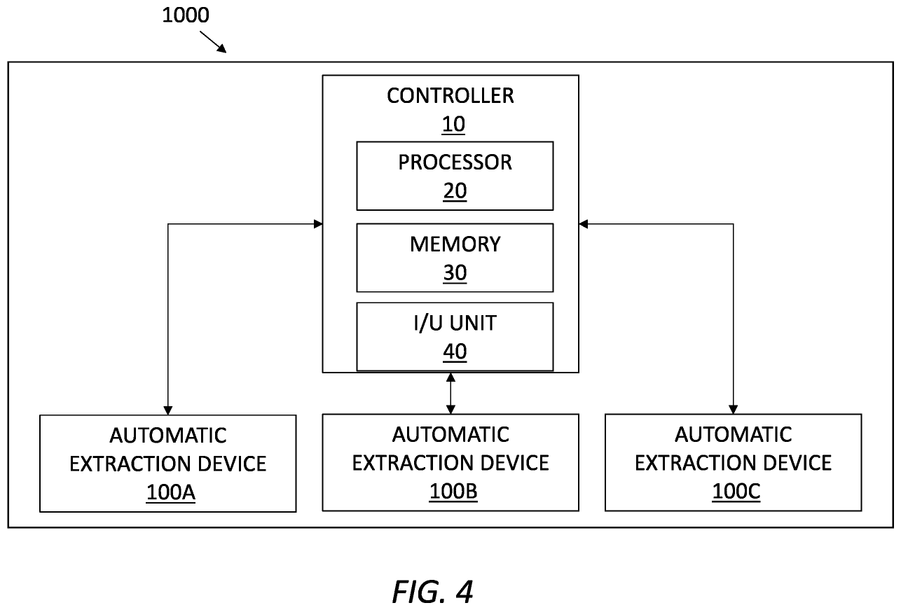

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Aspects of the invention may be directed to an automatic extraction device for extracting an oil substance from plant material. The plant material may be any known plant material that may be used for extracting oil using a solvent, such as, ethanol. The plant material (e.g., herbs, medicinal plant, tea, cannabis flowers, perfume plant, etc.) may be grinded/smashed prior to insertion to the device or may be inserted, as is. In some embodiments, the domestic automatic extraction device may be configured to be easily operated by any user while producing high quality oil substance.

In some embodiments, the automatic extraction device may be small and compact, for example, for domestic use, and can be placed on a kitchen or bathroom shelf. Additionally or alternatively, a system comprising two or more of such devices may be installed in a pharmacy or on any other suitable commercial site. The device may include three main units: a mixing tank, an evaporation system, and a condenser. As would be clear to the one skilled in the art, miniaturization of large commercial device for domestic/pharmacy/commercial purposes poses a great challenge. Some elements such as the evaporation system and the condenser require a large volume/free surface in order to work efficiently. Minimizing the size of these elements is a challenging task, for example, the total size of the condenser should be at most 1 cm³, for example, at most 0.9 cm³, 0.8 cm³, 0.7 cm³, 0.6 cm³, 0.5 cm³, 0.4 cm³, or less, and the total size of the evaporation system should be at most 1.7 cm³, for example, 1.5 cm³, 1.2 cm³, 1 cm³, 0.9 cm³, 0.7 cm³, 0.6 cm³, or less. Furthermore, the use of highly flammable solvents, such as, ethanol, introduce even greater challenge to a domestic system, the device must be safe for operation, even in a kitchen or in a pharmacy. Therefore, the automatic extraction device may include a closed sealed system for providing the solvent. In some embodiments, almost all (e.g., above 95 vol. %) the solvent used for extraction is recovered, by the condenser, and reused for further extraction.

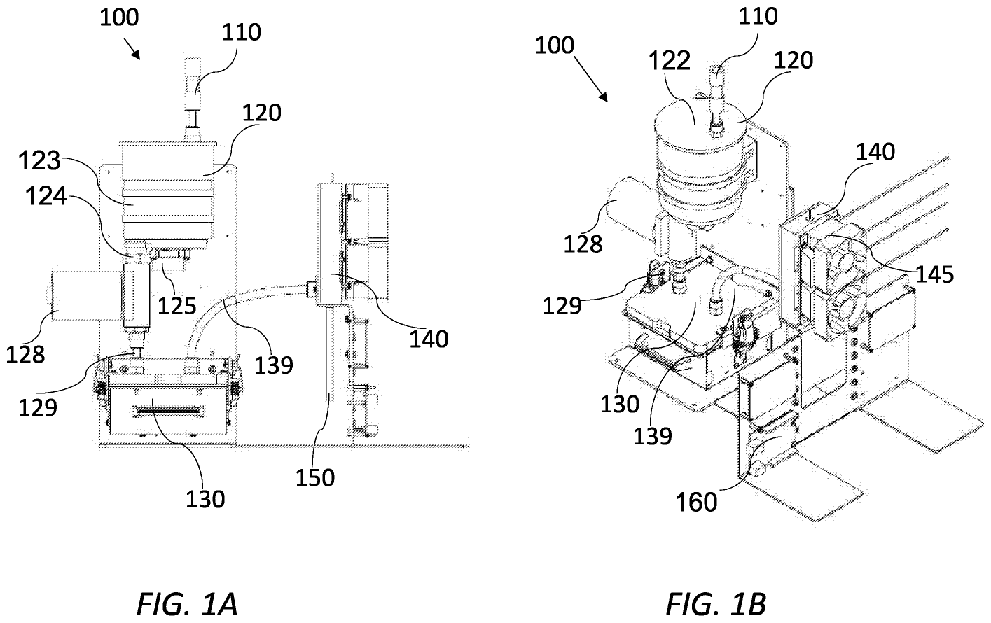

Reference is now made to FIGS. 1A and 1B which are illustrations of a front view and a perspective view of an automatic extraction device for extracting a liquid substance from plant material according to some embodiments of the invention. An automatic extraction device 100 may include a mixing tank 120, an evaporation system 130, and a condenser 140. In some embodiments, device 100 may further include a controller 160 for controlling the controllable components of device 100.

In some embodiments, device 100 may include a solvent (e.g., ethanol) supply 110 in fluid connection with mixing tank 120. In some embodiments, solvent supply 110 (e.g., a reservoir or a supply line) may provide solvent to the mixing tank. Solvent supply 110 may be in fluid connection with condenser 140 for providing condensed recovered/liquidized solvent from condenser 140 to supply 110 or directly to mixing tank 120.

Mixing tank 120 may include an entrance 122 for providing the plant material to a tank 123, a mixer 125 and an exit 124 for extracting a mixture of the solvent (e.g., ethanol) and the liquid substance (e.g., oil). In some embodiments, mixer 125 may be a magnetic mixer that includes a magnetic motor (as illustrated) configured to cause the movement of a magnetic stirrer (not illustrated) inside tank 123. In some embodiments, any alternative stirrer or stirring method can be provided by mixer 125. For example, mixer 125 may include a mechanical stirrer, one or more nozzles for providing the solvent to tank 123 in a pressure sufficient to stir the mixture in tank 123, and the like. In some embodiments, mixer 125 may be controlled by controller 160 to provide a predetermined stirring duration and/or intensity.

In some embodiments, device 100 may further include a valve 128 (e.g., a solenoid valve) for controlling the provision of the mixture of the solvent and the liquid substance to evaporation system 130 via pipe 129. In some embodiments, controller 160 may be configured to open valve 128 after a predetermined amount of time, following the insertion of the plant material or the initiation of the mixing. Alternatively, controller 160 may be configured to open valve 128 after the termination of the stirring/mixing of mixer 125. In some embodiments, controller 160 may be configured to close valve 128 to seal the evaporation system 130.

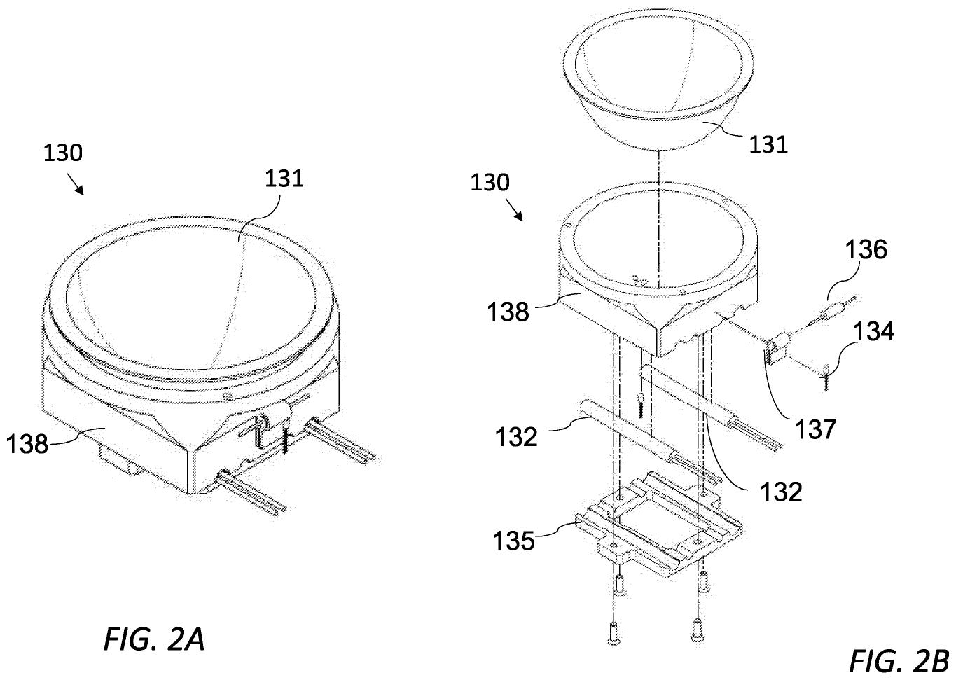

Reference is now made to FIGS. 2A and 2B, which are assembled view and exploded view illustrations of evaporation system 130 according to some embodiments of the invention. Evaporation system 130 may be configured to evaporate the solvent from the mixture, thus leaving only the liquid substance (e.g., oil) in a liquid state. System 130 may include a vessel 131 made from a thermoplastic polymer for receiving the mixture, and further for collecting the liquid substance following the evaporation of the solvent. In a nonlimiting example, vessel 131 may be made from, silicone, polytetrafluoroethylene or any other thermoplastic elastomer (TPE) or a thermoplastic rubber (TPR). In some embodiments, using thermoplastic polymers for vessel 131 may provide advantages over the use of known metals (e.g., aluminum alloys and stainless steels) and ceramics (e.g., glass, etc.) In some embodiments, although the efficiency of thermoplastics materials, when it comes to heat transfer, is lower than metals, these materials were chosen since it is easier to extract the oily product at the end of the process.

In some embodiments, evaporation system 130 may further include at least one heating element 132 (e.g., the illustrated two elements 132) placed at a distance from an external wall of the vessel. In some embodiments, the distance is determined based on the glass transition temperature (Tg) of the thermoplastic polymer and the power provided by at least one heating element 132, held by holder 135. The power may be determined as to cause vessel 131 to be heated to 80-140° C. and any temperature in between. As known to one skilled in the art, polymers (especially thermoplastic polymers) are very sensitive to heat and temperature, thus are not considered a “first or obvious choice” for a heated vessel. In some embodiments, an optimization process may be conducted in order to find the minimal distance between vessel 131 and at least one heating element 132 that will not deform the polymer of vessel 131 while still providing sufficient heat to the mixture, for example, for heating the mixture to 80-140° C. In some embodiments, at least one heating element 132 may be any heating element that may provide heat to vessel 131 (e.g., metallic, ceramic, semiconductor, etc.) In some embodiments, controller 160 may be configured to control the duration and amount of power provided to at least one heating element 132. In some embodiments, evaporation system 130 may further include a safety fuse 136 located in a fuse housing 137 for disconnecting the power from at least one heating element 132 in case of an emergency.

In some embodiments, evaporation system 130 may further include at least one thermometer 134 configured to measure the temperature of the mixture in vessel 131. In some embodiments, controller 160 may be configured to control the power provided to at least one heating element 132 based on signals received from at least one thermometer 134. In nonlimiting examples, thermometer 134 may be installed on an external wall of holder 135, attached to an external wall of vessel 131, and the like. In another nonlimiting example, thermometer 134 may be attached to the bottom external portion of vessel 131.

In some embodiments, evaporation system 130 may further include heating block 138 for heating vessel 131 130. In some embodiments, heating block 138 may be designed to transfer heat to from heating elements 132 to vessel 131.

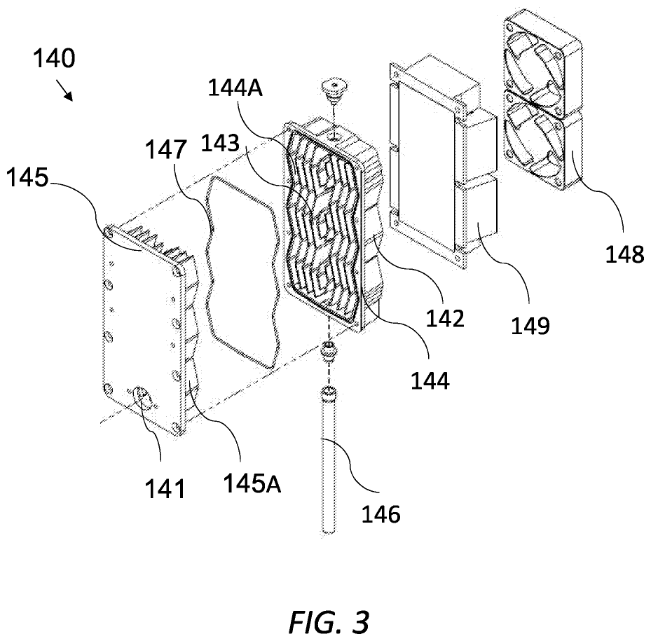

Reference is now made to FIG. 3 which is an exploded view of condenser 140 included in domestic automatic extraction device 100 according to some embodiments of the invention. Condenser 140 may be configured to receive the evaporated solvent form system 130 and condense the evaporated solvent into liquid. Condenser 140 may include an entrance 141 in gas connection with evaporation system 130 and a housing 142 having a maximum external volume of at most 1 liter, 0.9 liter, 0.8 liter, 0.7 liter, 0.6, liter 0.5 liter, for example, 0.4 liter, 0.3 liter, 0.2 liter, 0.1, liter or less. In some embodiments, hosing 142 may include an internal array of heatsinks 143, located inside housing 142, providing surface-to-volume ratio 4-0.5 [1/mm] (e.g., a ratio of, 3-1, [1/mm], 3-0.5 [1/mm], 2-1 [1/mm]. In a nonlimiting example of such ratio is 1.44 [1/mm]. In some embodiments, housing 142 may include two portions 144 and 145 configured to form a sealed housing, for example, using a sealing ring 147. In some embodiments, a first portion 144 may include a first group 144A of heatsinks from array 143 (connected to first portion 144) and a second portion 145 may include second group 145A of heatsinks from array 143 (connected to second portion 145). In some embodiments, when assembled, first group of heatsinks 144A is configured to intertwine with second group of heatsinks 145A.

In some embodiments, condenser 140 may further include an external ventilation system 148. In some embodiments, ventilation system 148 may include fans for evacuating heat from housing 142. In some embodiments, condenser 140 may further include additional elements configured to evacuate heat from housing 142, for example, thermoelectric plates, heat pipes, liquid cooling, etc.

In some embodiments, condenser 140 may further include a collecting tube 146, in liquid connection to solvent reservoir/line 110, for collecting the condensed solvent. The collected solvent (e.g., ethanol) may be conveyed into reservoir 110 or directly to mixing tank 120 via line 110, for example, using a pump, or a system based on gravity.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An automatic extraction device for extracting a liquid substance from plant material, comprising:
a mixing tank, in liquid connection with the ethanol reservoir, comprising:
an entrance for providing the plant material;
a mixer, and
an exit for extracting a mixture of the ethanol and the liquid substance,
an evaporation system, in liquid connection to the mixing tank's exit, for evaporating the ethanol;
a condenser, for condensing the evaporated ethanol, the condenser comprising:
an entrance in gas connection with the evaporation system;
a housing having a maximum external volume of at most 1 liter; and
an internal array of heatsinks, located inside the housing, providing surface-to-volume ratio of 4-0.5 [1/mm]; and
a collecting tube, in liquid connection to the mixing tank, for collecting the condensed ethanol.

2. The automatic extraction device of claim 1, wherein the maximum external volume is at most 0.5 liter.

3. The automatic extraction device of claim 1, wherein the surface-to-volume ratio provided by the internal array of heatsinks is 2-1 [1/mm].

4. The automatic extraction device of claim 1, further comprising an ethanol supply in fluid connection to the mixing tank and the condenser.

5. The automatic extraction device of claim 1, wherein the housing comprises two portions configured to form a sealed housing, and wherein a first group of heatsinks from the array is connected to a first portion of the housing and a second group of heatsinks from the array is connected to a second portion of the housing.

6. The automatic extraction device of claim 5, wherein when assembled, the first group of heatsinks is configured to intertwine with the second group of heatsinks.

7. The automatic extraction device of claim 5, wherein the condenser further comprises an external ventilation system.

8. The automatic extraction device of claim 1, further comprising a controller configured to control at least the mixer and the evaporation system.

9. The automatic extraction device of claim 1, wherein the evaporation system comprises:
a vessel for receiving the mixture, the vessel being made from a thermoplastic polymer; and
at least one heating element placed in a distance from an external wall of the vessel,
wherein the distance is determined based on the Tg of the thermoplastic polymer and the power provided by the at least one heating element, as to cause the ethanol in the vessel to be heated to 80-140 C.

10. An automatic extraction device for extracting a liquid substance from plant material, comprising:
an ethanol reservoir;
a mixing tank, comprising:
an entrance for providing the plant material;
a mixer, in liquid connection with the ethanol reservoir; and
an exit for extracting a mixture of the ethanol and the liquid substance,
an evaporation system, in liquid connection to the mixing thank exit, for evaporating the ethanol; and
a condenser, for condensing the evaporated ethanol,
wherein the evaporation system comprises:
a vessel for receiving the mixture, the vessel being made from a thermoplastic polymer; and
at least one heating element placed in a distance from an external wall of the vessel, wherein the distance is determined based on the Tg of the thermoplastic polymer and the power provided by the at least one heating element, as to cause the vessel to be heated to 80-140 C.

11. The automatic extraction device of claim 10, wherein the thermoplastic polymer is selected from, silicone, Polytetrafluoroethylene, thermoplastic elastomer and thermoplastic rubber.

12. The automatic extraction device of claim 10, further comprising a controller configured to control a power provided to the at least one heating element to heat the ethanol in the vessel to a temperature of at least 80-140 C.

13. The automatic extraction device of claim 12, further comprising a thermometer configured to measure the temperature of the mixture in the vessel and wherein the controller is configured to control the power provided to the heating elements based on signals received from the thermometer.

14. The automatic extraction device of claim 13, wherein the thermometer is a thermistor attached to a wall of the vessel.

15. The automatic extraction device of claim 10, further comprising a holder for holding the vessel and the at least one heating element.

16. The automatic extraction device of claim 10, wherein the condenser comprises:
an entrance in gas connection with the evaporation system;
a housing having a maximum external volume of at most 1 liter;
and an internal array of heatsinks, located inside the housing, providing surface-to-volume ratio of 4-0.5 [1/mm]; and
a collecting tube, in liquid connection to the mixing tank, for collecting the condensed ethanol.

17. A system for automatic extraction of a liquid substance from plant material, comprising:
two or more automatic extraction devices; and
a controller configured to:
control the provision of power to each one of the two or more automatic extraction devices separately,
wherein each automatic extraction devices comprises:
a mixing tank, in liquid connection with the ethanol reservoir, comprising:
an entrance for providing the plant material;
a mixer; and
an exit for extracting a mixture of the ethanol and the liquid substance,
an evaporation system, in liquid connection to the mixing tank's exit, for evaporating the ethanol;
a condenser, for condensing the evaporated ethanol; and
a collecting tube, in liquid connection to the mixing tank, for collecting the condensed ethanol.

18. The system of claim 17, wherein the condenser comprises:
an entrance in gas connection with the evaporation system;
a housing having a maximum external volume of at most 1 liter;
and an internal array of heatsinks, located inside the housing, providing surface-to-volume ratio of 4-0.5 [1/mm].

19. The system of claim 17, wherein the evaporation system comprises:
a vessel for receiving the mixture, the vessel being made from a thermoplastic polymer; and
at least one heating element placed in a distance from an external wall of the vessel, wherein the distance is determined based on the Tg of the thermoplastic polymer and the power provided by the at least one heating element, as to cause the ethanol in the vessel to be heated to 80-140 C.

20. The system of claim 17, wherein the controller is configured to control at least the mixer and the evaporation system.

21. (canceled)
